(19) United States
(12) Patent Application Publication
(10) Pub. No.: US 2021/0082077 A1
(43) Pub. Date: Mar. 18, 2021

(54) SYSTEMS AND METHODS FOR INTEGRATING PROVIDER ACCEPTANCE PROBABILITY INTO TRANSPORTATION MATCHING

(71) Applicant: Lyft, Inc., San Francisco, CA (US)

(72) Inventors: Mayank Gulati, San Francisco, CA (US); Charles Parker Spielman, San Francisco, CA (US); Kirshna Kumar Selvam, San Francisco, CA (US); Aleksandr Zamoshchin, San Francisco, CA (US); Arthur Jean, François Braud, San Francisco, CA (US)

(21) Appl. No.: 16/718,131

(22) Filed: Dec. 17, 2019

Related U.S. Application Data
(60) Provisional application No. 62/900,530, filed on Sep. 14, 2019.

(51) Int. Cl. G06Q 50/30; G06Q 30/06

(52) U.S. Cl. CPC G06Q 50/30; G06N 7/005; G06Q 30/0629

(57) ABSTRACT

The disclosed dynamic transportation matching system may include a non-transitory memory and one or more hardware processors configured to execute instructions from the non-transitory memory to perform operations including receiving transportation requests from requestor devices. The dynamic transportation matching system may also identify a set of transportation provider devices and determine an acceptance probability for each provider device to determine a likelihood of accepting a transportation request. Additionally, the dynamic transportation matching system may match a provider device to each transportation request, based on the acceptance probabilities of each provider device for each transportation request, and send the transportation requests to the matched provider devices. Furthermore, the dynamic transportation matching system may send updates about the matches to the requestor devices. Various other methods, systems, and computer-readable media are also disclosed.

### CROSS REFERENCE TO RELATED APPLICATION

This application claims the benefit of U.S. Provisional Application No. 62/900,530, filed 14 Sep. 2019, the disclosure of which is incorporated, in its entirety, by this reference. This application relates to co-pending application Ser. Nos. [TBD] and [TBD], filed on same day herewith, the disclosures of which are incorporated, in their entirety, by this reference.

### BACKGROUND

Transportation matching systems may dynamically match transportation requestor devices with available transportation provider devices to provide on-demand transportation options for requestors while finding suitable matches for providers. For example, a transportation provider with an automobile may be matched to provide transportation to a nearby transportation requestor. Traditionally, a central transportation matching system may find matches by calculating simple data about the request, such as the distance or estimated time of arrival from a transportation provider device to a transportation requestor device or a pickup location.

However, after receiving a matched transportation request at a transportation provider device, a provider may decline the match for various reasons. For example, the transportation provider may be switching to an inactive state that is not yet verified by the transportation provider device. Some providers may also cancel a matched transportation request, after initially accepting, due to various factors such as a destination that is too far for the provider. In these examples, the matching system may need to find an alternate transportation provider device for the transportation request. However, due to delays in waiting for a response from the transportation provider device and additional delays to match an alternate transportation provider, a transportation requestor may wait longer than expected for transportation.

These delays may inconvenience a transportation requestor and may cause the transportation requestor to cancel a request. Additionally, a canceled request may then inconvenience a matched transportation provider. Thus, the instant disclosure identifies and addresses a need for additional and improved systems and methods for dynamically matching transportation requests to reduce inconvenience and wait time for both transportation requestors and transportation providers.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an illustration of an example projected transportation request.

FIG. 2 is an illustration of an example active transportation request.

FIG. 3 is an illustration of an example adjustment to an active transportation request.

FIG. 4 is a block diagram of the dynamic transportation matching system integrating provider acceptance probability into transportation matching for an example transportation request.

FIG. 5 is a block diagram of example provider acceptance probabilities calculated using example historical records.

FIG. 6 is a block diagram of example adjustments of acceptance probabilities using example recent historical records of transportation providers.

FIG. 7 is a block diagram of example calculations of conversion scores.

FIG. 8 is a block diagram of example updates to historical and recent records for a transportation provider.

FIG. 9 is an illustration of example provider matches based on conversion maximization in comparison to minimizing estimated times of arrival.

FIG. 10 is a block diagram of an example adjustment of a transportation match for multiple transportation requests.

FIG. 11 is an illustration of an example provider match for a transportation request.

FIG. 12 is an illustration of example provider matches for multiple transportation requests.

FIG. 13 is a flow diagram of an example method for integrating provider acceptance probability into transportation matching.

FIG. 14 is an illustration of an example dynamic transportation matching system environment.

FIG. 15 is an illustration of an example requestor/provider management environment.

FIG. 16 is an illustration of an example data collection and application management system.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to systems and methods for integrating provider acceptance probability into transportation matching. In some examples, the terms “acceptance probability” and “provider acceptance probability” generally refer to a likelihood of a transportation provider accepting a transportation request if the request is matched and sent to the transportation provider, where the acceptance of the transportation request indicates an intention to fulfill the transportation request. As will be explained in greater detail below, embodiments of the instant disclosure may, by calculating a probability that a transportation provider device accepts a matched transportation request, match transportation provider devices with transportation requests to increase the likelihood of acceptance of the transportation requests. For example, a dynamic transportation matching system may identify multiple active transportation provider devices capable of accepting a transportation request. The disclosed systems and methods may then calculate an acceptance probability for each of the transportation provider devices by examining a historical record of matches for each transportation provider device.

Additionally, the disclosed systems and methods may adjust the acceptance probability of a transportation provider device based on a recent historical record. For example, the most recent record of a transportation provider device may indicate the transportation provider device is currently not accepting transportation matches, despite historically accepting matches, and may have a lower acceptance probability. As a further example, the systems and methods disclosed herein may send the transportation request to the transportation provider device most likely to accept the particular transportation request, as determined by the calculated acceptance probabilities, among other potential factors. The disclosed systems and methods may also track the outcome of the transportation request and update the historical record of the transportation provider device to improve future matches.

Thus, the systems and methods described herein may improve the likelihood of completing transportation requests by matching requests with transportation provider devices with high acceptance probabilities. In some examples, the disclosed systems and methods may adjust matching different transportation provider devices with multiple transportation requests to increase the likelihood of completing all of the transportation requests. These systems and methods may also improve the experience for transportation requestors by decreasing the potential wait times and decreasing the possibility of lapses after initial provider acceptance of requests while also improving the experience for transportation providers by matching them with transportation requests that are more likely to fit provider preferences. Additionally, the disclosed systems and methods may account for potential requestors during matching and may provide more accurate initial estimated times of arrival for potential requestors during matching by reserving matched transportation providers. By incorporating provider acceptance probabilities into a matching scheme, the disclosed systems and methods may therefore improve the likelihood of providing automated transportation matches. By calculating conversion scores that indicate the likelihood of completing transportation for matched requests, the disclosed systems and methods may also improve the efficiency of the matching scheme to increase fulfillment of more transportation requests.

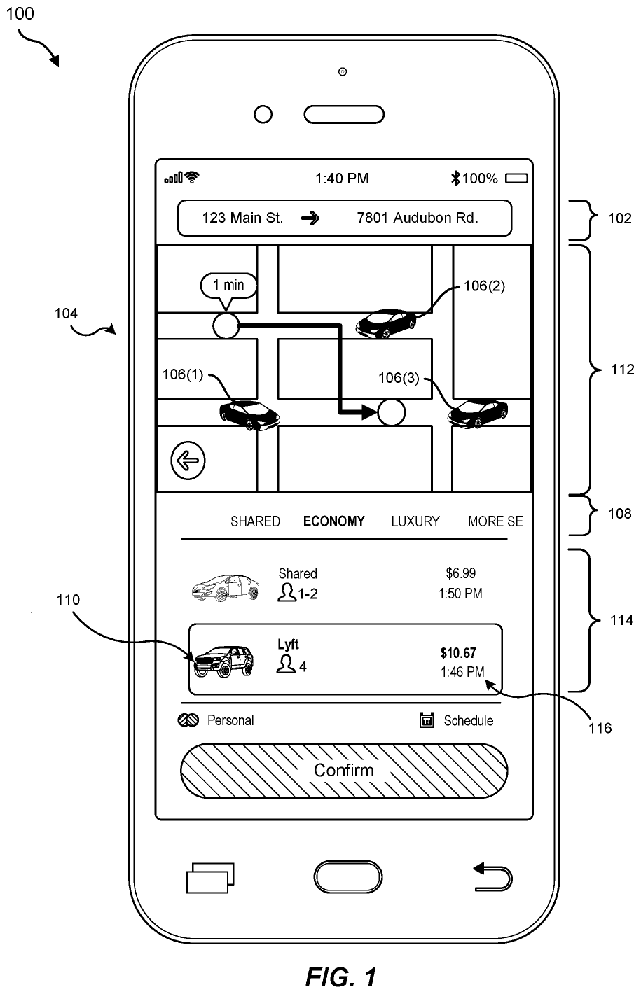

FIG. 1 illustrates a projected transportation request on an example transportation requestor device. As illustrated in FIG. 1, a projected request 100 may represent a transportation request 102 that includes a starting location, an ending location, and/or a projected route. As used herein, the term “projected request” may generally refer to a transportation request that is expected but not yet formally requested or confirmed. For example, a requestor may search for a possible route to a destination before determining whether to request transportation.

In the example of FIG. 1, a requestor device 104 may include a graphical display with a map display region 112 displaying a visual representation of transportation request 102 and nearby provider devices 106(1)-(3), represented as images of vehicles on an interface of requestor device 104. Additionally, in some examples, an initial estimated time of arrival 116 (e.g., “1:46 PM”) may be determined for projected request 100 and displayed by requestor device 104 as part of a currently selected offer 110 in an offer display region 114 of the graphical display. Furthermore, multiple modes of transportation may be presented as part of a mode selector region 108, with separate estimated times of arrival (e.g., “1:50 PM”) calculated for each mode of transportation and displayed by requestor device 104 in offer display region 114. In additional examples, one of provider devices 106(1)-(3) may be preemptively reserved for projected request 100. In this example, the reserved provider device may then be excluded from calculations for estimated times of arrival for other projected requests.

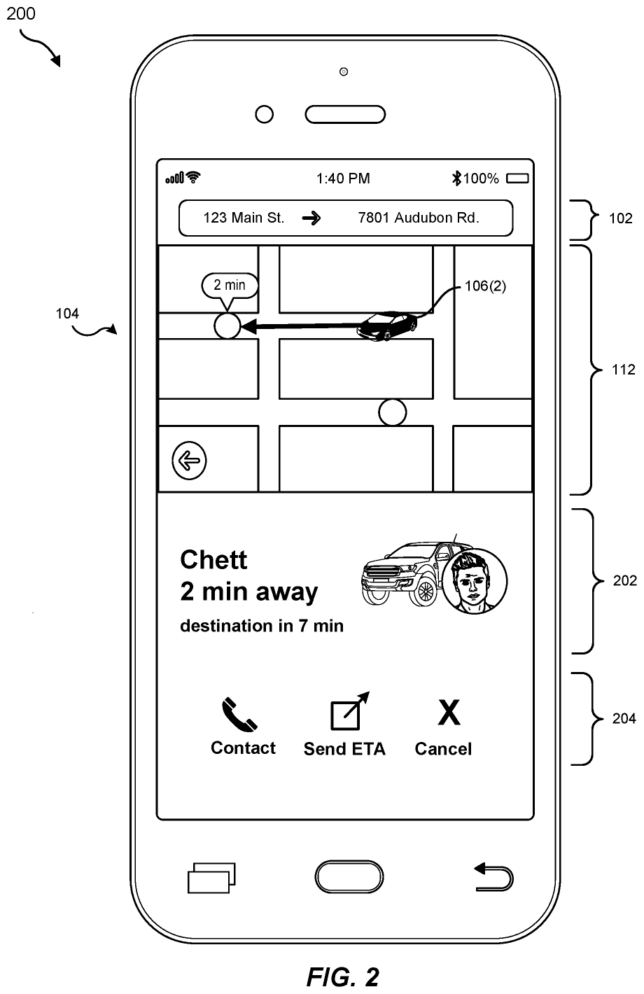

FIG. 2 illustrates an active transportation request for a provider device with a requestor device. As illustrated in FIG. 2, an active request 200 may represent transportation request 102 matched to provider device 106(2) and displayed on requestor device 104. As used herein, the term “active request” may generally represent a formal transportation request that has been confirmed by a requestor device. In this example, active request 200 may be sent to provider device 106(2) and an updated estimated time of arrival may be displayed as part of a match display region 202 on requestor device 104 based on a location of matched provider device 106(2). Additionally, requestor device 104 may display updates to active request 200, such as a current location of provider device 106(2), prior to an arrival of provider device 106(2) as part of map display region 112. During this time period, a requestor may also cancel active request 200 by selecting a cancelation option in an interactive controls region 204.

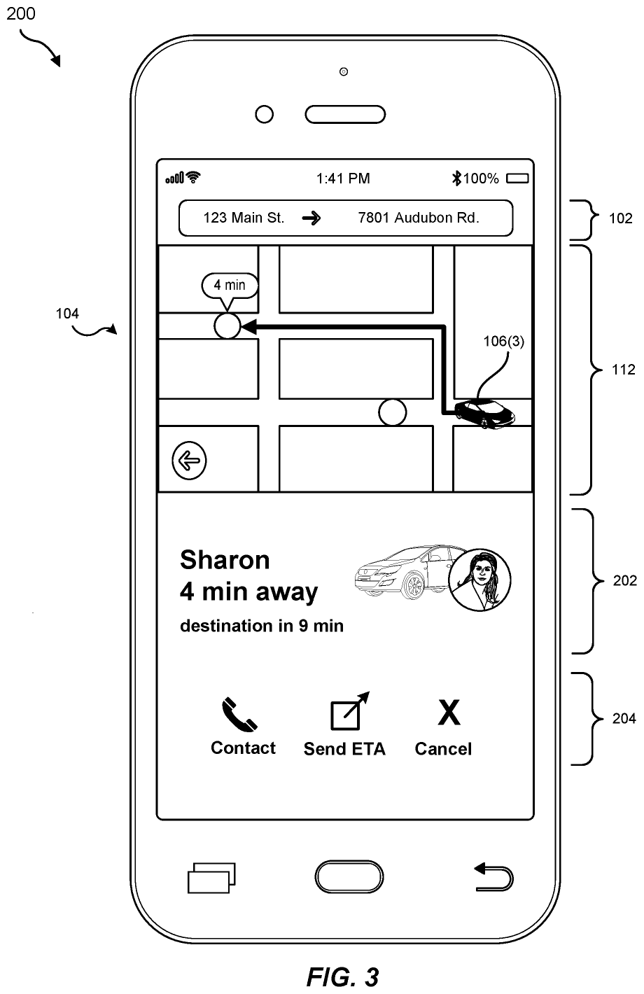

FIG. 3 illustrates an adjustment to the matching of a provider device with the requestor device for the active transportation request. As illustrated in FIG. 3, transportation request 102 may be alternately matched to provider device 106(3) and estimated time of arrival may be updated based on the alternate matching. In this embodiment, provider device 106(2) may decline or cancel the match and provider device 106(1) may be unavailable. Alternatively, provider device 106(2) may lapse after accepting the match, requiring a new transportation provider for transportation request 102. As used herein, the term “lapse” generally refers to a failure to complete a transportation request after accepting the request. Thus, a new match to provider device 106(3) may be selected from available provider devices and displayed in match display region 202, despite a longer estimated time of arrival, and transportation request 102 may be sent to provider device 106(3). Additionally, due to the longer estimated time of arrival, in addition to potential wait times during a lapse or while provider device 106(2) determines whether to accept a match, requestor device 104 may be more likely to cancel active request 200.

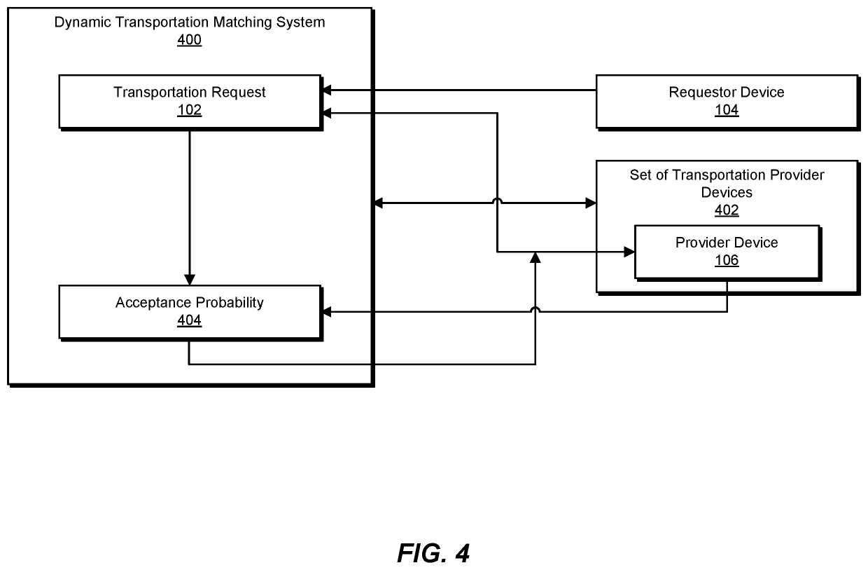

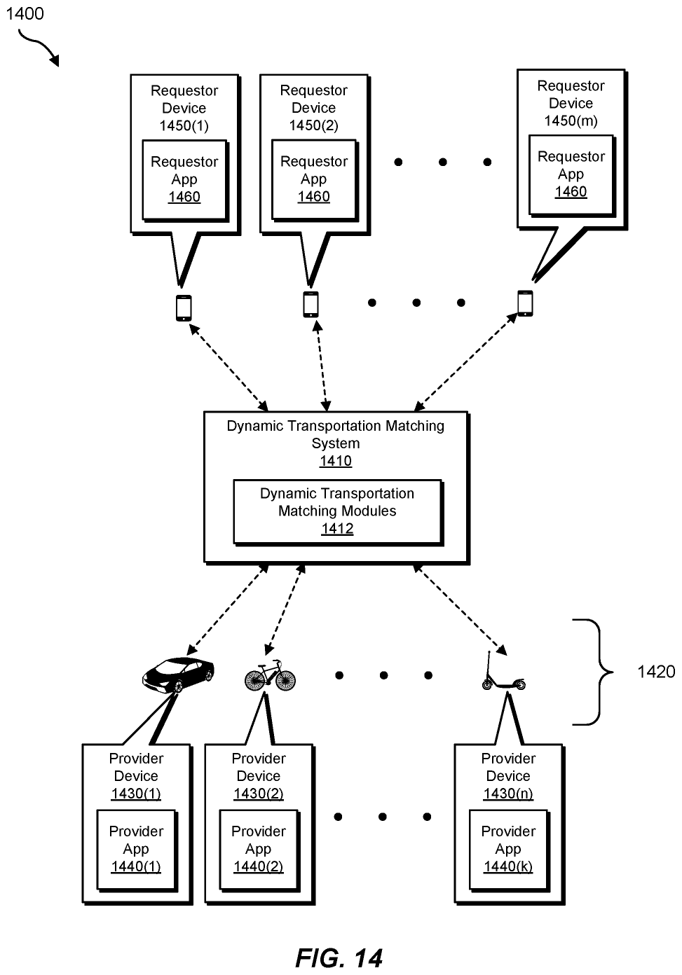

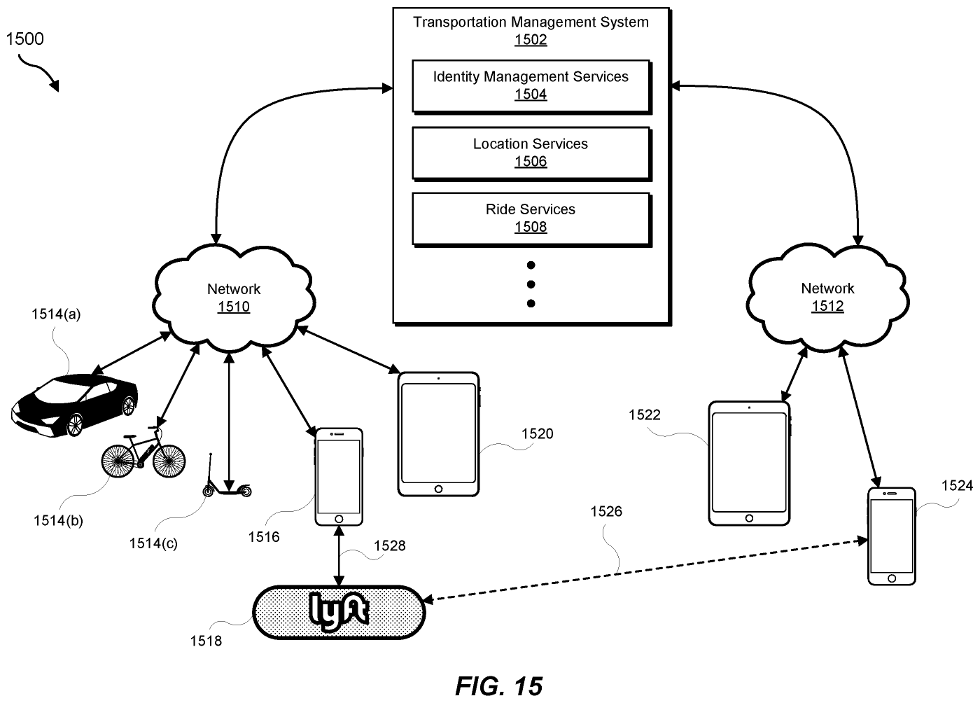

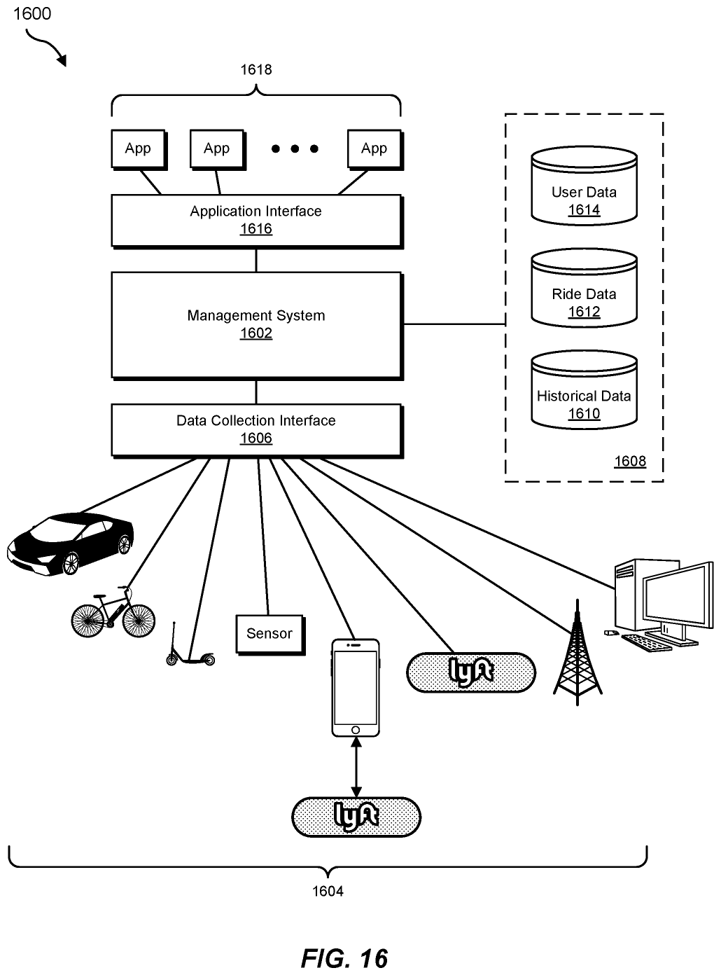

FIG. 4 is a block diagram of a dynamic transportation matching system 400 that integrates provider acceptance probability into transportation matching. In some examples, dynamic transportation matching system 400 may represent dynamic transportation matching system 1410 of FIG. 14, transportation management system 1502 of FIG. 15, and/or management system 1602 of FIG. 16. Additionally or alternatively, dynamic transportation matching system 400 may represent any computing system that communicates with requestor devices and provider devices and provides a service to match requestor devices with provider devices. Furthermore, dynamic transportation matching system 400 may be configured with one or more modules, stored in memory, that perform one or more of the steps described herein.

As shown in FIG. 4, dynamic transportation matching system 400 may first receive transportation request 102 from requestor device 104. In this example, dynamic transportation matching system 400 may also identify a set of transportation provider devices 402, which may include provider device 106. For example, dynamic transportation matching system 400 may identify active transportation provider devices within a geographical range of requestor device 104 and/or transportation request 102. In this example, the range of requestor device 104 may include a physical distance, such as a predefined or dynamically defined geographical region, and/or a length of time, such as an estimated time of arrival from a provider device's location to the starting location of a transportation request and/or an estimated time to fulfill the transportation request. Additionally, dynamic transportation matching system 400 may calculate an acceptance probability 404, for transportation request 102, for each provider device in the set of transportation provider devices 402. For example, dynamic transportation matching system 400 may determine acceptance probability 404, which indicates a likelihood that provider device 106 accepts transportation request 102 if matched. In this example, acceptance probability 404 may be calculated in a variety of ways, including but not limited to a naïve algorithm, a machine learning model, a weighted model, or any other methods based on historical and current data. Past acceptance and/or decline rates may also be modeled with a combination of request, provider, requestor, and environmental factors to determine the factors with the greatest impact on predicting provider acceptance of a match, and these factors may subsequently be used to predict acceptance probability 404.

Furthermore, dynamic transportation matching system 400 may match provider device 106 to transportation request 102 based on acceptance probability 404. In this example, dynamic transportation matching system 400 may select provider device 106 based on a higher acceptance probability 404 compared to other provider devices in set of transportation provider devices 402. By selecting provider device 106 based on higher acceptance probability 404, dynamic transportation matching system 400 may decrease the likelihood of a lapse or cancelation by provider device 106 or a cancelation by requestor device 104 due to long wait times, such as the example described in FIGS. 2-3. In addition, the decreased likelihood of lapses and cancelations may increase overall system efficiency (e.g., the efficiency of matches in terms of distance traveled by transportation providers and/or transportation requestors as against a minimum travel distance for transportation requestors). the decreased likelihood of lapses and cancelations may also increase utilization of transportation resources within the dynamic transportation network. These benefits may further reduce system latency and improve over traditional matching technologies. Finally, dynamic transportation matching system 400 may send transportation request 102 to matched provider device 106.

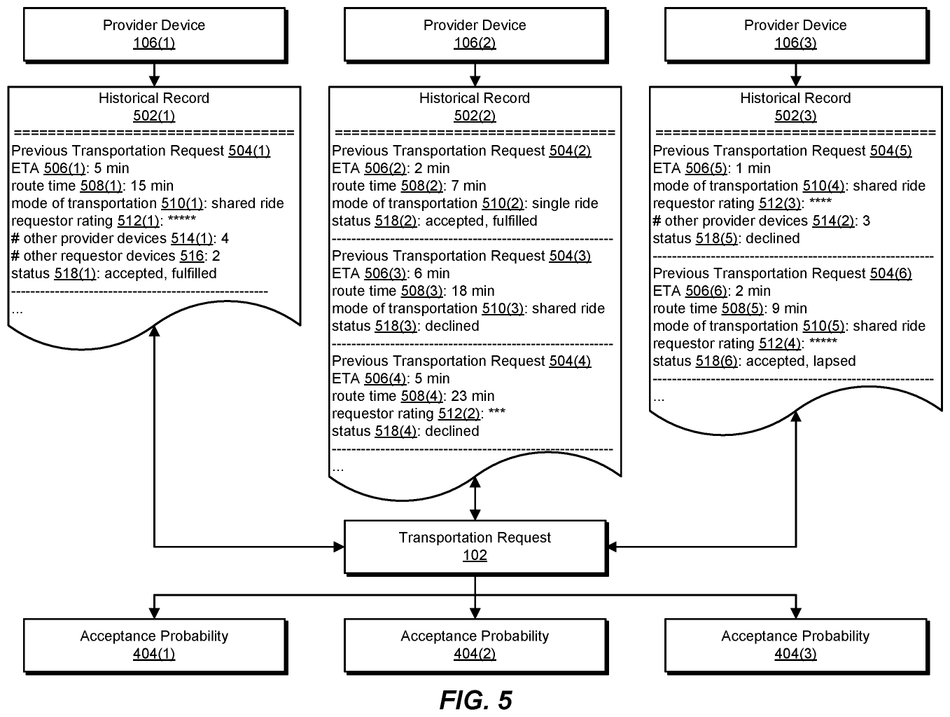

FIG. 5 is a block diagram of example acceptance probabilities determined using example historical records for multiple provider devices. As shown in FIG. 5, dynamic transportation matching system 400 of FIG. 4 may calculate acceptance probabilities 404(1)-(3) for each of provider devices 106(1)-(3). In one embodiment, dynamic transportation matching system 400 may determine a likelihood of each of provider devices 106(1)-(3) accepting a match to transportation request 102 by comparing transportation request 102 with historical records 502(1)-(3) of previous transportation requests 504(1)-(6) sent to provider devices 106(1)-(3). In this embodiment, historical records 502(1)-(3) may include information on estimated times of arrival 506(1)-(6) from a provider device's location at the time of a previous transportation request to a starting location of a previous transportation request, routes 508(1)-(5) of previous transportation requests, requestor ratings 512(1)-(4), and/or modes of transportation 510(1)-(5) used by the requestor. In some embodiments, information about the route of a previous request may also include data about the starting location, the ending location, an amount of time taken, a general location of the entire route (e.g., a geographical region or predefined region of service), an actual time of arrival, an idle time of provider devices 106(1)-(3) prior to receiving previous transportation requests 504(1)-(6), or other relevant data. For example, the information may also include a distance traveled during a route, a comparison of predicted data (such as the estimated time of arrival) with actual data (such as the actual time of arrival), a time of day of a transportation request (such as a specific hour, a day of the week, and/or whether the previous transportation request was during a known busy period), a previous location of a provider device, whether the provider indicated a preference to travel toward a particular location, device or application information from the provider device (such as a version of the application or specific device information), a provider vehicle type (e.g., whether the provider vehicle is classified as a luxury vehicle, which may indicate a greater likelihood that the provider accepts the match), and/or other provider data (such as a type of provider or user attributes). In some examples, dynamic transportation matching system 400 may determine acceptance probabilities based on one or more of the attributes described herein using a universal evaluation function (e.g., that does not take the particular provider into account). In other examples, dynamic transportation matching system 400 may determine acceptance probabilities based on one or more of the attributes described herein using a provider-specific evaluation function (e.g., that uses provider-specific information to determine how an attribute affects a likelihood of acceptance by a specific provider). For example, dynamic transportation matching system 400 may determine acceptance probabilities based on the time of day, the day of week, provider location, requestor pick-up location, weather, etc., on a provider-specific basis.

In some embodiments, a mode of transportation may include individual rides, shared rides, the use of a personal mobility vehicle, a different type of provider vehicle, or any other form of transportation or combinations of forms of transportation. For example, historical record 502(1) of provider device 106(1) includes details about previous transportation request 504(1), such as estimated time of arrival 506(1) (e.g., five minutes), total route time 508(1) (e.g., 15 minutes), requestor rating 512(1) (e.g., five stars), and mode of transportation 510(1) (e.g., a shared ride). In this example, a shared ride may represent multiple transportation requests combined to a single route and fulfilled by a single transportation provider, while an individual ride may represent a single transportation request fulfilled by a transportation provider. Furthermore, in some examples, a type of provider vehicle may influence acceptance probability based on requestor preferences. For example, a luxury vehicle may incur a higher cost, which may result in less frequent transportation requests for the particular mode of transportation, and providers with luxury vehicles may have higher acceptance rates due to the comparative rarity of requests for luxury modes of transportation.

Additionally or alternatively, historical records 502(1)-(3) may include a number of other active provider devices, such as numbers of other provider devices 514(1) and 514(2), and/or a number of other active requestor devices, such as number of other requestor devices 516, within the range of provider devices 106(1)-(3) at the time of the requests. In this embodiment, a number of active provider devices and/or requestor devices within a geographical area may indicate a transportation matching density of a location, which may impact acceptance probabilities or a likelihood of cancelation from requestor devices. For example, for a high density of requestors in an area with a limited number of transportation providers, a transportation provider may be less likely to accept matches that are not ideal and/or that have longer estimated times of arrival, due to a higher demand for transportation providers. Conversely, for an area with a low density of requestors but a high number of transportation providers, requestor devices may be more likely to cancel a match with a long estimated time of arrival, with the assumption that a larger supply of transportation providers may enable a requestor to more easily find an alternate transportation provider. Additionally, a larger supply of transportation providers may indicate a lower estimated time of arrival for an alternate transportation provider if a first provider declines a match.

In additional embodiments, historical records 502(1)-(3) may include statuses 518(1)-(6) indicating either provider devices accepting previous transportation requests and/or declining previous transportation requests. For example, status 518(1) of historical record 502(1) may indicate that previous transportation request 504(1) was accepted and fulfilled by provider device 106(1). In another example, status 518(5) of historical record 502(3) may indicate previous transportation request 504(5) was declined by provider device 106(3). Additionally, in this example, previous transportation request 504(6) may have been accepted but provider device 106(3) may have lapsed in fulfilling previous transportation request 504(6), such as by canceling after accepting or failing to provide transportation. In some examples, higher lapse rates and/or higher decline rates may predict a lower acceptance probability for a provider. Conversely, a higher historical rate of acceptance may also predict a higher current acceptance probability for a provider.

In the example of FIG. 5, known details about transportation request 102 may be compared to historical records 502(1)-(3) to find similarities in accepted or declined past transportation requests. For example, historical record 502(2) may indicate provider device 106(2) accepted previous transportation request 504(2) due to low estimated time of arrival 506(2) (e.g., 2 minutes) but declined previous transportation requests 504(3) and 504(4) due to higher estimated times of arrival 506(3)-(4) (e.g., 6 minutes and 5 minutes, respectively). In this example, historical record 502(2) may indicate provider device 106(2) may be more likely to decline higher estimated times of arrival during periods with more transportation requests but may have a higher likelihood of accepting matches with a low estimated time of arrival. In the example of FIG. 2, transportation request 102 may indicate an estimated time of arrival of 2 minutes for provider device 106(2), which may be low in comparison to historical record 502(2). Thus, dynamic transportation matching system 400 may determine a high value for acceptance probability 404(2) by leveraging historical record 502(2) to find similarities with current transportation request 102.

In another example, historical record 502(2) may indicate provider device 106(2) accepted previous transportation request 504(2) due to mode of transportation 510(2) being a single ride but declined previous transportation request 504(3) due to mode of transportation 510(3) being a shared ride. In this example, acceptance probabilities 404(1)-(3) may be based on modes of transportation 510(1)-(5). For example, dynamic transportation matching system 400 may determine transportation request 102 uses a shared ride service and may determine a low numerical value for acceptance probability 404(2). Alternatively, dynamic transportation matching system 400 may determine acceptance probabilities 404(1)-(3) for provider devices 106(1)-(3) based on the route of transportation request 102 and features of routes of previous transportation requests 504(1)-(6), such as the starting location, the ending location, the amount of time taken, and/or the length of the route. In further examples, other factors and/or a combination of the above factors may be used to determine acceptance probabilities 404(1)-(3) depending on the attributes of transportation request 102. Additionally, each factor may be dynamically weighted based on the significance of the factor in determining acceptance probabilities 404(1)-(3). Specifically, each factor may be influenced by existing environmental conditions, such as weather or traffic, and/or market conditions (e.g., provider and requestor density in a region), and may be weighted based on these existing conditions. For example, inclement weather and/or traffic may increase estimated times of arrival, which may be adjusted to reflect the current conditions.

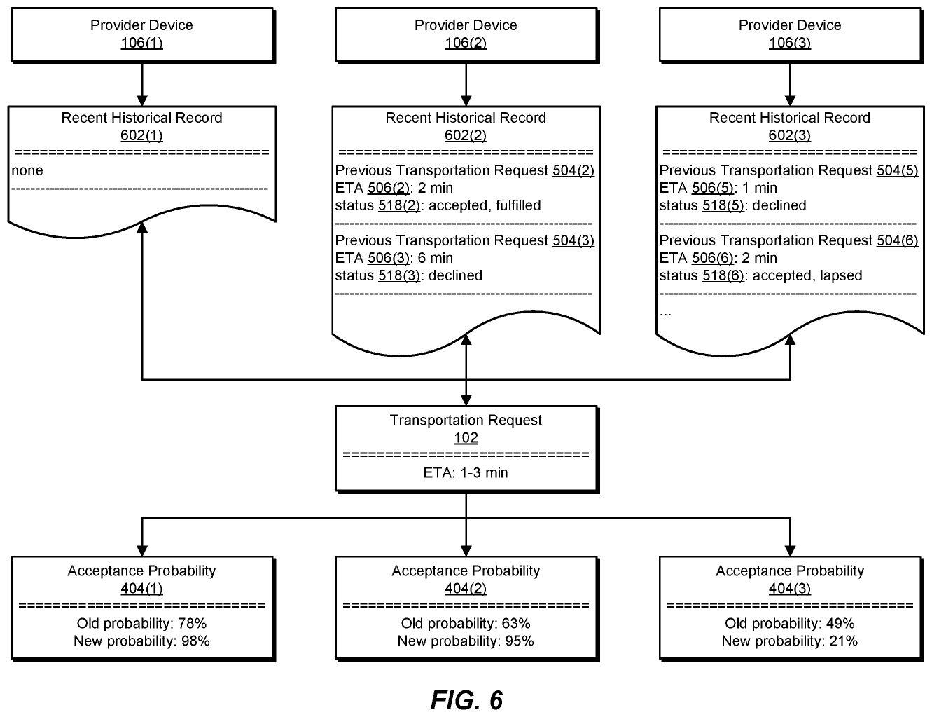

FIG. 6 is a block diagram of example adjustments to acceptance probabilities using recent historical records of transportation providers. As shown in FIG. 6, recent historical records 602(1)-(3) may include portions of historical records 502(1)-(3) and may be truncated within a time frame and/or by geographical region. In these embodiments, the time frame may be determined using various methods based on a predictiveness of acceptance probabilities 404(1)-(3). For example, recent historical records 602(1)-(3) may each indicate a single session on a provider app for provider devices 106(1)-(3) to avoid conflating the records of different acceptance rates during previous sessions. As another example, the time frame may represent a recent period of time, such as within one hour, during which provider devices 106(1)-(3) were active. In additional examples, the time frame may expand to include sessions across longer periods, such as a full day, weeks, and/or months, particularly for more stable probabilities of provider devices with unchanging match preferences. In some examples, the time frame may be based on a threshold number of events. For example, recent historical records may be based on the last five (or two, or three, or ten, etc.) transportation requests received by a provider. Thus, for example, dynamic transportation matching system 400 may evaluate the likelihood of acceptance of a request by a provider based at least in part on how many of the last five transportation requests received by the transportation provider were accepted or rejected (or, e.g., whether the last five requests were rejected, whether the last five requests were accepted, etc.).

In some embodiments, dynamic transportation matching system 400 of FIG. 4 may determine acceptance probabilities 404(1)-(3) by adjusting the likelihood of each provider device accepting the match based on recent historical records 602(1)-(3). For example, recent historical record 602(1) of provider device 106(1) may indicate a new session has been started on provider device 106(1), which may indicate provider device 106(1) is ready to accept transportation request 102. In this example, a provider device that recently opened a transportation matching application may be likely to have just started to accept transportation requests. In contrast, recent historical record 602(3) of provider device 106(3) may indicate provider device 106(3) is leaving a session and may decline transportation request 102. In this example, based on historical records, provider device 106(3) may be determined to routinely accept transportation requests during certain periods of time and/or at certain times of a day, and recent historical record 602(3) may indicate a current time is likely near the end of a typical session for provider device 106(3). For transportation request 102, an estimated time to fulfill the request may extend past an expected end of the session for provider device 106(3) and/or a destination location of the request may be outside of a preferred range for the transportation provider. Therefore, provider device 106(3) may have lower acceptance probability 404(3), given recent historical record 602(3). Similar to the example of FIG. 5, recent historical record 602(2) of provider device 106(2) may indicate a likelihood of accepting transportation request 102 due to a low estimated time of arrival (e.g., 1-3 minutes). By emphasizing recent historical records in contrast to older records, dynamic transportation matching system 400 may identify more relevant data influencing a current state of a transportation provider.

In additional embodiments, dynamic transportation matching system 400 of FIG. 4 may identify and/or predict trends affecting acceptance probabilities by comparing recent historical records 602(1)-(3) with similar time frames in older sessions from historical records 502(1)-(3). For example, historical record 502(2) of provider device 106(2) in FIG. 5 may indicate provider device 106(2) historically accepts more transportation requests during the latter part of a calendar week. In this example, dynamic transportation matching system 400 may determine that transportation request 102 initiates during the latter part of a current week and that recent historical record 602(2) indicates provider device 106(2) is beginning to accept more transportation requests, following previous trends in historical record 502(2). In the above embodiments, dynamic transportation matching system 400 may then weight each of acceptance probabilities 404(1)-(3) based on trends and predictions indicated by recent historical records 602(1)-(3) to update to new probabilities. In some examples, as described herein, dynamic transportation matching system 400 of FIG. 4 may determine acceptance probabilities 404(1)-(3) based at least in part on a current status of the transportation requestor, the transportation provider, and/or the transportation environment.

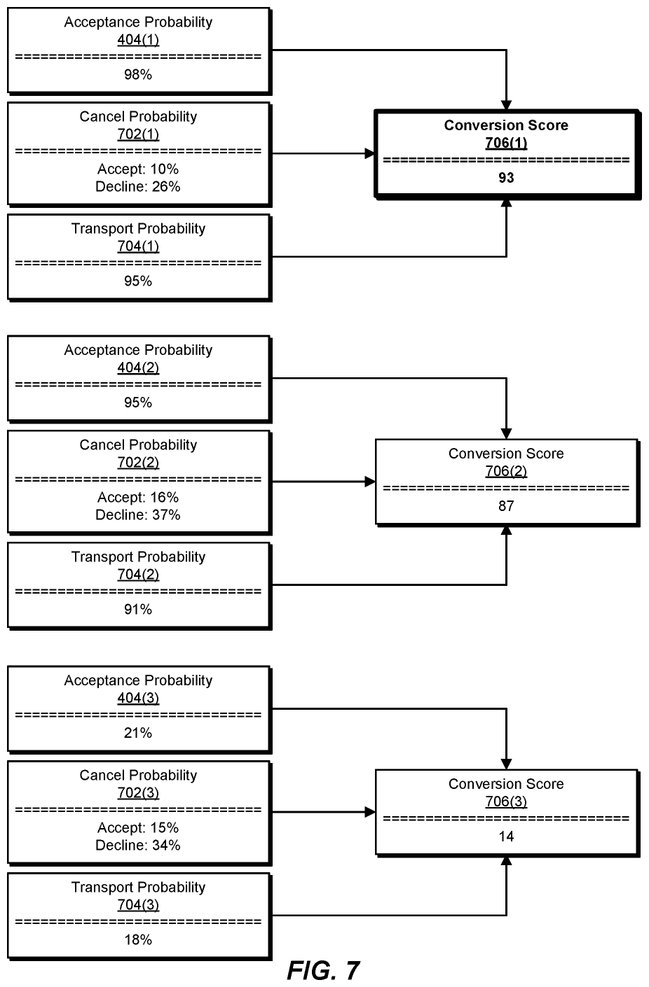

FIG. 7 is a block diagram of example calculations of conversion scores. In some examples, the term “conversion score” may generally refer to a likelihood of completing a requestor pickup for a transportation request. In other examples, the term “conversion score” may refer to a likelihood of completing the transportation request or reaching the destination. Specifically, higher acceptance probabilities, lower cancel probabilities, and higher transport probabilities may lead to higher conversion scores. As previously described, an acceptance probability may include a likelihood of a transportation provider accepting a transportation request if the request is matched and sent to the transportation provider. A cancel probability may indicate a likelihood of a requestor canceling a transportation request after initiating the request. A transport probability may represent a likelihood of a completion of a transportation request after the transportation request is accepted by a transportation provider.

In one embodiment, as shown in FIG. 7, dynamic transportation matching system 400 may calculate conversion scores 706(1)-(3) for provider devices 106(1)-(3) based on acceptance probabilities 404(1)-(3), with higher conversion scores corresponding to higher acceptance probabilities. Additionally, conversion scores 706(1)-(3) may be calculated using cancel probabilities 702(1)-(3) indicating a probability of requestor device 104 canceling transportation request 102, with higher conversion scores corresponding to lower cancel probabilities. In some examples, cancel probabilities 702(1)-(3) may include separate probabilities of cancelation for a possible acceptance of a match and a possible declining of a match, which may necessitate finding an alternate match. Furthermore, conversion scores 706(1)-(3) may be calculated using transport probabilities 704(1)-(3) indicating a likelihood of an acceptance of transportation request 102 resulting in a physical transport of a requestor and/or a completion of transportation request 102. In some embodiments, conversion scores 706(1)-(3) may use a combination of the above probabilities, which may be weighted differently and/or compared based on expected values. For example, conversion scores for matches that are likely to be accepted may depend more heavily on cancel probabilities and transport probabilities of the matched requestors and providers. In another example, conversion scores for matches with requestors who are unlikely to cancel, such as in low-density provider areas, may depend more heavily on provider attributes that contribute to acceptance probabilities and transport probabilities.

In the example of FIG. 7, dynamic transportation matching system 400 of FIG. 4 may then match provider device 106(1) to transportation request 102 by determining that conversion score 706(1) indicates provider device 106(1) is most likely to complete transportation request 102. In this example, conversion score 706(1) may represent the highest score due to high acceptance probability 404(1), low cancel probability 702(1), and high transport probability 704(1). In additional examples, dynamic transportation matching system 400 may match provider device 106(1) to transportation request 102 using other information, such as the route or destination of transportation request 102, in addition to acceptance probability 404(1) to calculate conversion score 706(1) to facilitate improving future matches.

In some embodiments, provider device 106(1) with the highest conversion score may potentially decline transportation request 102 and/or cause a lapse, such as by canceling, after accepting. In these embodiments, dynamic transportation matching system 400 may match an alternate provider device to transportation request 102 based on the conversion scores of the remaining provider devices. For example, conversion score 706(2) may represent the highest score among available provider devices, and provider device 106(2) may match to transportation request 102. However, provider device 106(2) may also decline or cause a lapse, and dynamic transportation matching system 400 may continue to match the best available provider device based on the conversion scores. Additionally, after each declined or lapsed match, transportation request 102 may incur increases to the estimated time of arrival, which may increase a likelihood of requestor device 104 canceling transportation request 102 such that transportation request 102 may not survive to be matched to an alternate provider device. Thus, dynamic transportation matching system 400 may evaluate matches by calculating the conversion score of each matched provider device while factoring in the likelihood of transportation request 102 surviving, or not being canceled. Furthermore, with each subsequent match and increase in the estimated time of arrival, the likelihood of cancelation may increase for transportation request 102. In these embodiments, dynamic transportation matching system 400 may model the value of transportation request 102 as a summation of the products of each conversion score with the likelihood of surviving to a particular match.

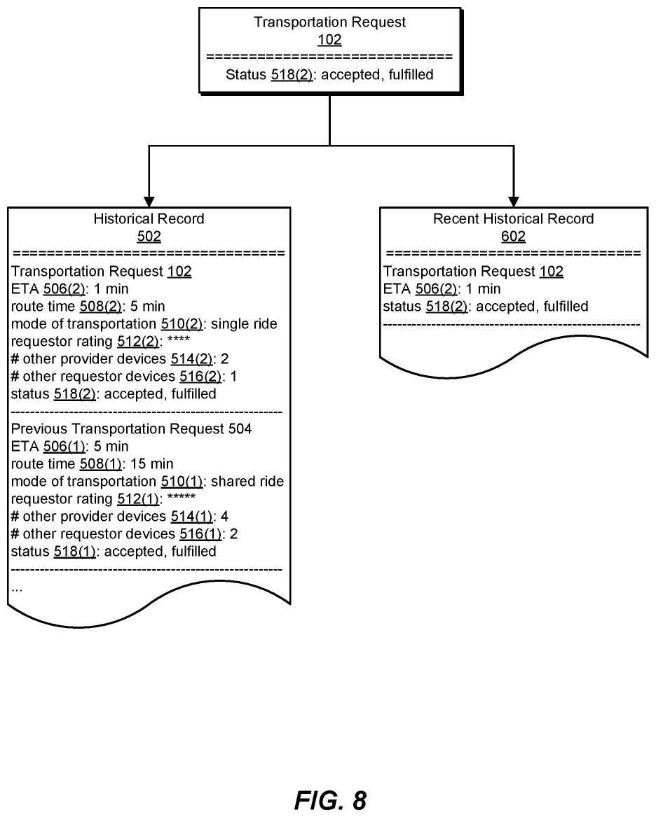

FIG. 8 is a block diagram of updates to historical and recent records for a matched transportation provider. As shown in FIG. 8, dynamic transportation matching system 400 of FIG. 4 may track a status 518(2) of transportation request 102 (e.g., accepted and fulfilled) after sending transportation request 102 to provider device 106 of FIG. 4. In this embodiment, dynamic transportation matching system 400 may then update a historical record 502 and a recent historical record 602 to include information about transportation request 102 in addition to a previous transportation request 504. In additional embodiments, dynamic transportation matching system 400 may update other provider device and/or requestor device information to improve calculations of acceptance probability 404 used to match future requests. By continually updating historical records with more recent matches, dynamic transportation matching system 400 may ensure future matches are made using the most relevant and up-to-date data, such as the most recent acceptance rates for a provider device, to predict acceptance probabilities.

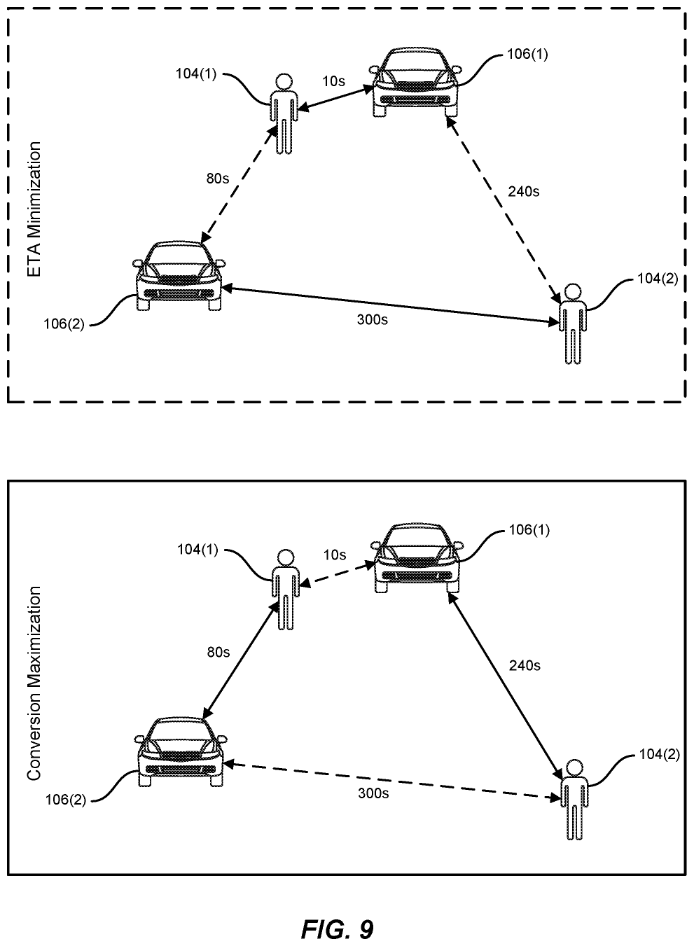

FIG. 9 is an illustration of example provider matches based on conversion maximization in comparison to minimizing estimated times of arrival. As shown in FIG. 9, dynamic transportation matching system 400 of FIG. 4 may match provider devices 106(1) and 106(2) to requestor devices 104(1) and 104(2) by maximizing total conversion scores rather than minimizing total estimated times of arrival, which may be performed by traditional systems. In the example of FIG. 9, minimizing estimated time of arrival may match provider device 106(1) to requestor device 104(1) (e.g., 10s estimated time of arrival) while matching provider device 106(2) to requestor device 104(2) (e.g., 300s) for a total time of 310s. In contrast, matching provider device 106(2) to requestor device 104(1) (e.g., 80s) and provider device 106(1) to requestor device 104(2) (e.g., 240s) may result in a higher total time of 320s. However, due to requestor's cancel probability increasing with longer wait times, an estimated time of arrival of 300s may exponentially increase the likelihood of requestor device 104(2) canceling a match. By decreasing the estimated time of arrival for requestor device 104(2), dynamic transportation matching system 400 may increase the likelihood of requestor device 104(2) completing a matched ride while not significantly decreasing the likelihood of requestor device 104(1) completing a matched ride, resulting in a higher overall conversion score. By adjusting for higher conversion scores across all transportation requests, dynamic transportation matching system 400 may increase the likelihood of continued engagement by both requestors and providers with dynamic transportation matching system 400.

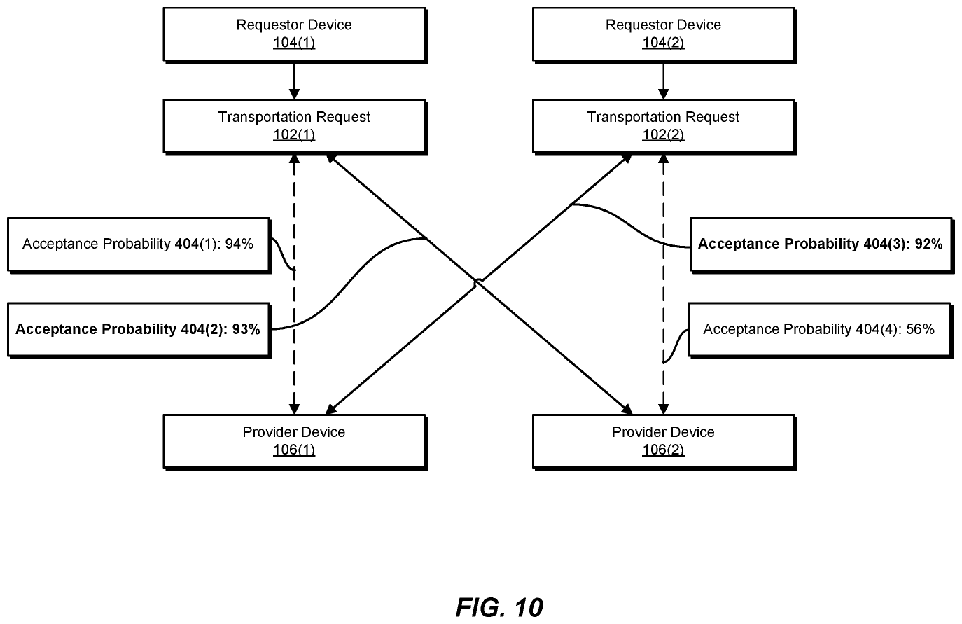

FIG. 10 is a block diagram of an example adjustment of a transportation match for multiple transportation requests. As shown in FIG. 10, dynamic transportation matching system 400 of FIG. 4 may first receive transportation request 102(1) from requestor device 104(1) and match provider device 106(1) to transportation request 102(1) based on a high acceptance probability, such as acceptance probability 404(1) of FIG. 7 (e.g., 98%). In this example, dynamic transportation matching system 400 may then receive an additional transportation request 102(2) from an additional requestor device 104(2) and adjust acceptance probability 404(1) (e.g., to 94%) based on transportation request 102(2). In this example, acceptance probabilities may decrease for areas with more requestor devices and/or provider devices that represent a busy, high-density location. Furthermore, acceptance probabilities may be adjusted based on locations of other provider devices. For example, acceptance probability 404(1) may be adjusted higher or lower due to a proximity of provider device 106(2) to provider device 106(1), with the proximity determined as a threshold radius of physical distance and/or time difference for estimated times of arrival.

Additionally, dynamic transportation matching system 400 may adjust a match of provider device 106(1) to transportation request 102(1) to improve an overall acceptance probability for transportation request 102(1) and transportation request 102(2), similar to the example of FIG. 9 in improving overall conversion. In this example, dynamic transportation matching system 400 may match provider device 106(1) to an alternate transportation request, such as transportation request 102(2). Furthermore, dynamic transportation matching system 400 may match an alternate provider device, such as provider device 106(2), to transportation request 102(1). Although provider device 106(2) has a lower acceptance probability 404(2) (e.g., 93%) than provider device 106(1) for transportation request 102(1), matching provider device 106(2) to transportation request 102(1) may enable provider device 106(1) to be matched to transportation request 102(2) for a higher overall acceptance probability, which may include a higher acceptance probability within dynamic transportation matching system 400 and/or a higher acceptance probability for a combination of sets of providers and requestors. In this example, the tradeoff for a slightly lower acceptance probability for transportation request 102(1) may result in a much higher acceptance probability for transportation request 102(2), with acceptance probability 404(3) significantly higher than acceptance probability 404(4). Accordingly, transportation matches between transportation requestor devices and provider devices may be matched with an objective of maximizing conversion scores at a system level in addition to a granular, provider level, depending on the conditions and transportation matching density of the geographic area.

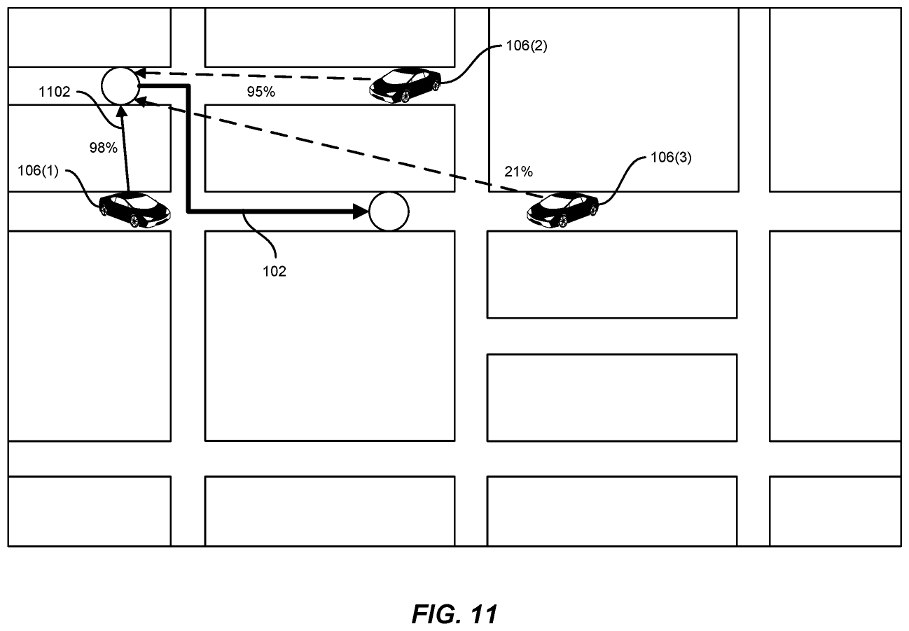

FIG. 11 illustrates a match of a provider device to a single transportation request. As illustrated in FIG. 11, provider devices 106(1)-(3) may be identified for transportation request 102. In this example, provider devices 106(1)-(3) may be identified as potential provider devices due to a proximity to a starting location of transportation request 102 or due to operation in the same area as transportation request 102. In other examples, provider devices 106(1)-(3) may be filtered by a requestor device, such as by selecting a preferred type of vehicle.

Additionally, acceptance probabilities may be calculated for each of provider devices 106(1)-(3) for transportation request 102 to find a match among provider devices 106(1)-(3) that is most likely to be accepted. Furthermore, a match 1102 between provider device 106(1) and transportation request 102 may be selected from potential matches, and transportation request 102 may be sent to provider device 106(1) as a result of match 1102.

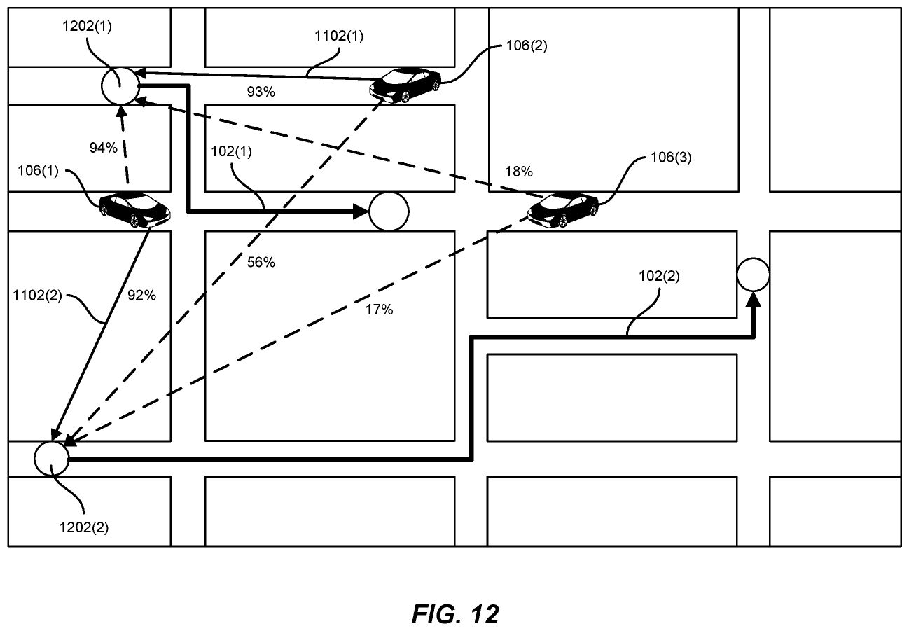

FIG. 12 illustrates matches of different provider devices to multiple transportation requests, similar to FIG. 9. As illustrated in FIG. 12, transportation request 102(1) may represent transportation request 102 of FIG. 11 with a starting location 1202(1) indicating a location of a first requestor device, and transportation request 102(2) may represent an additional transportation request with a starting location 1202(2) received by dynamic transportation matching system 400 of FIG. 4 from a second requestor device at the same time as or within a short time from receiving transportation request 102(1). In this embodiment, dynamic transportation matching system 400 may attempt to simultaneously match provider devices to transportation requests 102(1) and 102(2). For example, dynamic transportation matching system 400 may adjust the acceptance probabilities of provider devices 106(1)-(3) from the acceptance probabilities of FIG. 11 to the acceptance probabilities of FIG. 12. In this example, provider devices may be more likely to decline transportation requests or requestor devices may cancel requests in a busy area with more options. Conversely, provider devices may be more likely to accept a transportation request and requestor devices may be less likely to cancel when fewer alternate options are available, even with longer estimated times of arrival. By adjusting acceptance probabilities based on increasing overall acceptance, dynamic transportation matching system 400 may increase the likelihood of converting more transportation requests and, therefore, increased utilization of transportation matching.

Based on the adjusted acceptance probabilities and to improve an overall acceptance probability for both transportation request 102(1) and transportation request 102(2), dynamic transportation matching system 400 may adjust match 1102 of FIG. 11 to a new match 1102(1) and a match 1102(2) of FIG. 12. In this example, lower acceptance probabilities may be calculated for provider devices 106(2) and 106(3) for transportation request 102(2), while provider device 106(1) may have a higher acceptance probability (e.g., 92%). The acceptance probabilities may be influenced, in part, by a distance to starting locations 1202(1)-(2). Thus, dynamic transportation matching system 400 may send transportation request 102(2), rather than transportation request 102(1), to provider device 106(1) to increase a likelihood of both transportation request 102(1) and transportation request 102(2) being accepted, which may additionally lead to higher overall conversion scores for transportation requests 102(1)-(2). While acceptance probability of transportation request 102(1) is higher for provider device 106(1), it may be more efficient for dynamic transportation matching system 400 to match provider device 106(1) with transportation request 102(2) to enable higher system utilization and, thereby, increased efficiency, reduced latency, and improved overall user experiences for both providers and requestors. In other words, in contrast to traditional methods of maximizing matches based only on estimated times of arrival, maximizing overall acceptance probabilities may additionally lead to maximizing overall conversion scores.

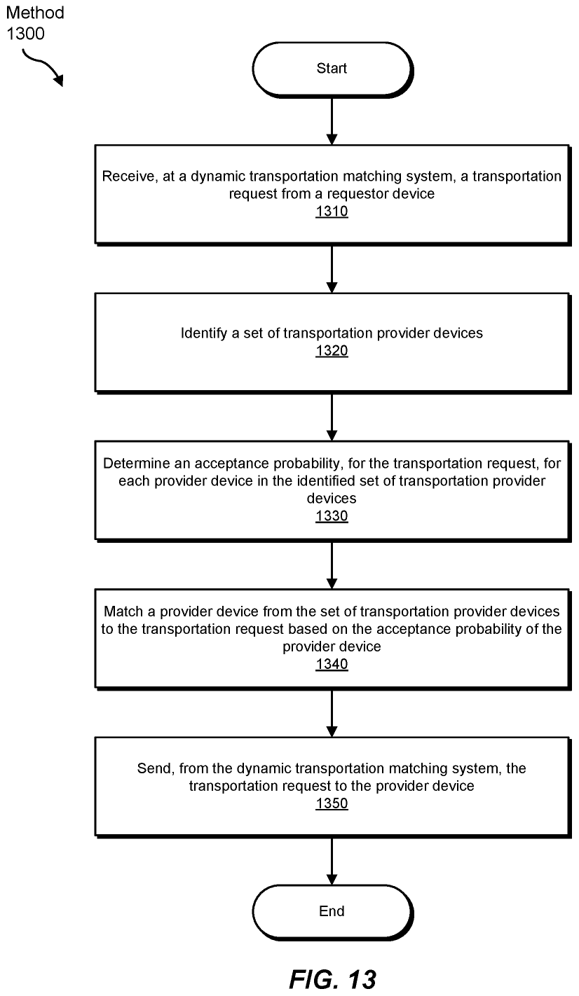

FIG. 13 is flow diagram of an example method 1300 for integrating provider acceptance probability into transportation matching. As illustrated in FIG. 13, at step 1310, one or more of the systems described herein may receive, at a dynamic transportation matching system, a transportation request from a requestor device.

In one embodiment, the dynamic transportation matching system may receive the transportation request by receiving an active request from an active requestor. Additionally or alternatively, the dynamic transportation matching system may receive a projected request from a potential requestor.

At step 1320, one or more of the systems described herein may identify a set of transportation provider devices. In some embodiments, the dynamic transportation matching system may identify the set of transportation provider devices based on a requirement of the transportation request and/or a location of the set of transportation provider devices within a defined and/or dynamically determined area.

At step 1330, one or more of the systems described herein may determine an acceptance probability, for the transportation request, for each provider device in the identified set of transportation provider devices.

In some examples, the dynamic transportation matching system may determine the acceptance probability for a provider device by determining a likelihood of the provider device accepting a match to the transportation request. In some embodiments, determining a likelihood of the provider device accepting the match may include comparing the transportation request with a historical record of transportation requests sent to and/or received by the provider device. In these examples, the historical record of transportation requests sent to the provider device may include data associated with an estimated time of arrival and/or an actual time of arrival from a provider device's location to a starting location of a previous transportation request, a route of the previous transportation request, a rating of a requestor, a mode of transportation used by the requestor, an idle time of the provider device prior to receiving the previous transportation request, a number of other active provider devices within a range of the provider device, and/or a number of other active requestor devices within the range of the provider device. Additionally, the historical record of transportation requests may include a status indicating the provider device accepting or declining the previous transportation request and/or the provider device fulfilling the previous transportation request or a lapse of the provider device for the previous transportation request.

In additional embodiments, the dynamic transportation matching system may track a status of the transportation request and update a historical record of transportation requests sent to the provider device. Thus, the historical record may include an updated historical record of transportation requests created based on tracking the status of the transportation request.

In additional examples, the dynamic transportation matching system may determine the acceptance probability of the provider device by adjusting the likelihood of the provider device accepting the match based on a recent historical record of the provider device, where the recent historical record includes a portion of the historical record within a time frame. In some examples, the time frame may be determined based on previous and/or current conditions in a location of the transportation request and/or the provider device, including a current number of other provider devices and/or other requestor devices within the range of the provider device.

At step 1340, one or more of the systems described herein may match a provider device from the set of transportation provider devices to a requestor device associated with the transportation request based on the acceptance probability of the provider device.

In some embodiments, the dynamic transportation matching system may match the provider device to a requestor device associated with the transportation request by calculating a conversion score for each provider device based on the acceptance probability (i.e., a higher conversion score based on a higher likelihood of a transportation provider accepting a matched request), a probability of an acceptance of the transportation request converting to a physical transport (i.e., a higher conversion score based on a higher likelihood of the transportation provider fulfilling the matched request), and a probability of the requestor device canceling the transportation request (i.e., a lower conversion score based on a higher likelihood of cancelation). Additionally, the dynamic transportation matching system may match the provider device to the transportation request based on the conversion score of the provider device.

At step 1350, one or more of the systems described herein may send, from the dynamic transportation matching system, the transportation request to the provider device.

In one example, the dynamic transportation matching system may send the transportation request to the provider device by sending an active request to the provider device. In this example, the dynamic transportation matching system may also update an estimated time of arrival on the requestor device for the active request.

In another example, the dynamic transportation matching system may reserve the provider device for a projected request. In this example, the dynamic transportation matching system may send the estimated time of arrival to the requestor device for the projected request. By reserving the provider device for the projected request, the dynamic transportation matching system may provide a more accurate estimated time of arrival to the requestor device and, additionally, remove the reserved provider device from the set of provider devices used to match subsequent transportation requests, which may then provide more accurate estimated times of arrival for the subsequent transportation requests.

In further embodiments, the dynamic transportation matching system may receive one or more additional transportation requests from one or more additional requestor devices. In these embodiments, the dynamic transportation matching system may adjust the acceptance probability of the provider device for the transportation request based on the one or more additional transportation requests. The dynamic transportation matching system may then determine, based on the adjustment, that one or more additional transportation requests have higher conversion scores than the transportation request for the provider device. Furthermore, the dynamic transportation matching system may adjust a match of the provider device to the transportation request to improve an overall acceptance probability for the transportation request and each additional transportation request by matching the provider device to an alternate transportation request and matching an alternate provider device to the transportation request based on the higher conversion scores.

FIG. 14 illustrates an example system 1400 for matching transportation requests with a dynamic transportation network that includes personal mobility vehicles. As shown in FIG. 14, a dynamic transportation matching system 1410 may be configured with one or more dynamic transportation matching modules 1412 that may perform one or more of the steps described herein. Dynamic transportation matching system 1410 may represent any computing system and/or set of computing systems capable of matching transportation requests. Dynamic transportation matching system 1410 may be in communication with computing devices in each of a group of vehicles 1420. Vehicles 1420 may represent any vehicles that may fulfill transportation requests. In some examples, vehicles 1420 may include disparate vehicle types and/or models. For example, vehicles 1420 may include road-going vehicles and personal mobility vehicles. In some examples, some of vehicles 1420 may be standard commercially available vehicles. According to some examples, some of vehicles 1420 may be owned by separate individuals (e.g., transportation providers). Furthermore, while, in some examples, many or all of vehicles 1420 may be human-operated, in some examples many of vehicles 1420 may also be autonomous (or partly autonomous). Accordingly, throughout the instant disclosure, references to a “transportation provider” (or “provider”) may, where appropriate, refer to an operator of a human driven vehicle, an autonomous vehicle control system, an autonomous vehicle, an owner of an autonomous vehicle, an operator of an autonomous vehicle, an attendant of an autonomous vehicle, a vehicle piloted by a requestor, and/or an autonomous system for piloting a vehicle. While FIG. 14 does not specify the number of vehicles 1420, it may be readily appreciated that the systems described herein are applicable to hundreds of vehicles, thousands of vehicles, or more. In one example, dynamic transportation matching system 1410 may coordinate transportation matchings within a single region for 50,000 vehicles or more on a given day. In some examples, vehicles 1420 may collectively form a dynamic transportation network that may provide transportation supply on an on-demand basis to transportation requestors.

As mentioned above, dynamic transportation matching system 1410 may communicate with computing devices in each of vehicles 1420. The computing devices may be any suitable type of computing device. In some examples, one or more of the computing devices may be integrated into the respective vehicles 1420. In some examples, one or more of the computing devices may be mobile devices. For example, one or more of the computing devices may be smartphones. Additionally or alternatively, one or more of the computing devices may be tablet computers, personal digital assistants, or any other type or form of mobile computing device. According to some examples, one or more of the computing devices may include wearable computing devices (e.g., a driver-wearable computing device), such as smart glasses, smart watches, etc. In some examples, one or more of the computing devices may be devices suitable for temporarily mounting in a vehicle (e.g., for use by a requestor and/or provider for a transportation matching application, a navigation application, and/or any other application suited for the use of requestors and/or providers). Additionally or alternatively, one or more of the computing devices may be devices suitable for installing in a vehicle and/or may be a vehicle's computer that has a transportation management system application installed on the computer in order to provide transportation services to transportation requestors and/or communicate with dynamic transportation matching system 1410.

As shown in FIG. 14, vehicles 1420 may include provider devices 1430(1)-(n) (e.g., whether integrated into the vehicle, permanently affixed to the vehicle, temporarily affixed to the vehicle, worn by a driver of the vehicle, etc.). In some examples, provider devices 1430 may include provider apps 1440(1)-(k). Provider apps 1440(1)-(k) may represent any application, program, and/or module that may provide one or more services related to operating a vehicle and/or providing transportation matching services. For example, provider apps 1440(1)-(k) may include a transportation matching application for providers and/or one or more applications for matching personal mobility vehicles (PMVs) with requestor devices. In some embodiments, different types of provider vehicles may be provisioned with different types of provider devices and/or different provider applications. For example, PMVs may be provisioned with provider devices that are configured with a provider application that enables transportation requestors to reserve and/or operate the PMV while road-constrained vehicles (e.g., cars) may be provisioned with provider devices that are configured with a provider application that enables provider vehicle operators (e.g., transportation providers) to respond to requests from transportation requestors. In some examples, provider applications 1440(1)-(k) may match the user of provider apps 1440(1)-(k) (e.g., a transportation provider) with transportation requestors through communication with dynamic transportation matching system 1410. In addition, and as is described in greater detail below, provider apps 1440(1)-(k) may provide dynamic transportation management system 1410 with information about a provider (including, e.g., the current location of the provider and/or vehicle) to enable dynamic transportation management system 1410 to provide dynamic transportation matching and/or management services for the provider and one or more requestors. In some examples, provider apps 1440(1)-(k) may coordinate communications and/or a payment between a requestor and a provider. According to some embodiments, provider apps 1440(1)-(k) may provide a map service, a navigation service, a traffic notification service, and/or a geolocation service.

Additionally, as shown in FIG. 14, dynamic transportation matching system 1410 may communicate with requestor devices 1450(1)-(m). In some examples, requestor devices 1450 may include a requestor app 1460. Requestor app 1460 may represent any application, program, and/or module that may provide one or more services related to requesting transportation matching services. For example, requestor app 1460 may include a transportation matching application for requestors. In some examples, requestor app 1460 may match the user of requestor app 1460 (e.g., a transportation requestor) with transportation providers through communication with dynamic transportation matching system 1410. In addition, and as is described in greater detail below, requestor app 1460 may provide dynamic transportation management system 1410 with information about a requestor (including, e.g., the current location of the requestor) to enable dynamic transportation management system 1410 to provide dynamic transportation matching services for the requestor and one or more providers. In some examples, requestor app 1460 may coordinate communications and/or a payment between a requestor and a provider. According to some embodiments, requestor app 1460 may provide a map service, a navigation service, a traffic notification service, and/or a geolocation service.

Embodiments of the instant disclosure may include or be implemented in conjunction with a dynamic transportation matching system. A transportation matching system may arrange transportation on an on-demand and/or ad-hoc basis by, e.g., matching one or more transportation requestors with one or more transportation providers. For example, a transportation matching system may provide one or more transportation matching services for a networked transportation service, a ridesourcing service, a taxicab service, a car-booking service, an autonomous vehicle service, a personal mobility vehicle service, or some combination and/or derivative thereof. The transportation matching system may include and/or interface with any of a variety of subsystems that may implement, support, and/or improve a transportation matching service. For example, the transportation matching system may include a matching system (e.g., that matches requestors to ride opportunities and/or that arranges for requestors and/or providers to meet), a mapping system, a navigation system (e.g., to help a provider reach a requestor, to help a requestor reach a provider, and/or to help a provider reach a destination), a reputation system (e.g., to rate and/or gauge the trustworthiness of a requestor and/or a provider), a payment system, and/or an autonomous or semi-autonomous driving system. The transportation matching system may be implemented on various platforms, including a requestor-owned mobile device, a computing system installed in a vehicle, a requestor-owned mobile device, a server computer system, or any other hardware platform capable of providing transportation matching services to one or more requestors and/or providers.

While various examples provided herein relate to transportation, embodiments of the instant disclosure may include or be implemented in conjunction with a dynamic matching system applied to one or more services instead of and/or in addition to transportation services. For example, embodiments described herein may be used to match service providers with service requestors for any service.

FIG. 15 shows a transportation management environment 1500, in accordance with various embodiments. As shown in FIG. 15, a transportation management system 1502 may run one or more services and/or software applications, including identity management services 1504, location services 1506, ride services 1508, and/or other services. Although FIG. 15 shows a certain number of services provided by transportation management system 1502, more or fewer services may be provided in various implementations. In addition, although FIG. 15 shows these services as being provided by transportation management system 1502, all or a portion of any of the services may be processed in a distributed fashion. For example, computations associated with a service task may be performed by a combination of transportation management system 1502 (including any number of servers, databases, etc.), one or more devices associated with a provider (e.g., devices integrated with managed vehicles 1514(a), 1514(b), and/or 1514(c); provider computing devices 1516 and tablets 1520; and transportation management vehicle devices 1518), and/or more or more devices associated with a ride requestor (e.g., the requestor's computing devices 1524 and tablets 1522). In some embodiments, transportation management system 1502 may include one or more general purpose computers, server computers, clustered computing systems, cloud-based computing systems, and/or any other computing systems or arrangements of computing systems. Transportation management system 1502 may be configured to run any or all of the services and/or software components described herein. In some embodiments, the transportation management system 1502 may include an appropriate operating system and/or various server applications, such as web servers capable of handling hypertext transport protocol (HTTP) requests, file transfer protocol (FTP) servers, database servers, etc.

In some embodiments, identity management services 1504 may be configured to perform authorization services for requestors and providers and/or manage their interactions and/or data with transportation management system 1502. This may include, e.g., authenticating the identity of providers and determining that they are authorized to provide services through transportation management system 1502. Similarly, requestors' identities may be authenticated to determine whether they are authorized to receive the requested services through transportation management system 1502. Identity management services 1504 may also manage and/or control access to provider and/or requestor data maintained by transportation management system 1502, such as driving and/or ride histories, vehicle data, personal data, preferences, usage patterns as a ride provider and/or as a ride requestor, profile pictures, linked third-party accounts (e.g., credentials for music and/or entertainment services, social-networking systems, calendar systems, task-management systems, etc.) and any other associated information. Transportation management system 1502 may also manage and/or control access to provider and/or requestor data stored with and/or obtained from third-party systems. For example, a requestor or provider may grant transportation management system 1502 access to a third-party email, calendar, or task management system (e.g., via the user's credentials). As another example, a requestor or provider may grant, through a mobile device (e.g., 1516, 1520, 1522, or 1524), a transportation application associated with transportation management system 1502 access to data provided by other applications installed on the mobile device. In some examples, such data may be processed on the client and/or uploaded to transportation management system 1502 for processing.

In some embodiments, transportation management system 1502 may provide ride services 1508, which may include ride matching and/or management services to connect a requestor to a provider. For example, after identity management services module 1504 has authenticated the identity a ride requestor, ride services module 1508 may attempt to match the requestor with one or more ride providers. In some embodiments, ride services module 1508 may identify an appropriate provider using location data obtained from location services module 1506. Ride services module 1508 may use the location data to identify providers who are geographically close to the requestor (e.g., within a certain threshold distance or travel time) and/or who are otherwise a good match with the requestor. Ride services module 1508 may implement matching algorithms that score providers based on, e.g., preferences of providers and requestors; vehicle features, amenities, condition, and/or status; providers' preferred general travel direction and/or route, range of travel, and/or availability; requestors' origination and destination locations, time constraints, and/or vehicle feature needs; and any other pertinent information for matching requestors with providers. In some embodiments, ride services module 1508 may use rule-based algorithms and/or machine-learning models for matching requestors and providers.

Transportation management system 1502 may communicatively connect to various devices through networks 1510 and/or 1512. Networks 1510 and 1512 may include any combination of interconnected networks configured to send and/or receive data communications using various communication protocols and transmission technologies. In some embodiments, networks 1510 and/or 1512 may include local area networks (LANs), wide-area networks (WANs), and/or the Internet, and may support communication protocols such as transmission control protocol/Internet protocol (TCP/IP), Internet packet exchange (IPX), systems network architecture (SNA), and/or any other suitable network protocols. In some embodiments, data may be transmitted through networks 1510 and/or 1512 using a mobile network (such as a mobile telephone network, cellular network, satellite network, or other mobile network), a public switched telephone network (PSTN), wired communication protocols (e.g., Universal Serial Bus (USB), Controller Area Network (CAN)), and/or wireless communication protocols (e.g., wireless LAN (WLAN) technologies implementing the IEEE 902.12 family of standards, Bluetooth, Bluetooth Low Energy, Near Field Communication (NFC), Z-Wave, and ZigBee). In various embodiments, networks 1510 and/or 1512 may include any combination of networks described herein or any other type of network capable of facilitating communication across networks 1510 and/or 1512.

In some embodiments, transportation management vehicle device 1518 may include a provider communication device configured to communicate with users, such as drivers, passengers, pedestrians, and/or other users. In some embodiments, transportation management vehicle device 1518 may communicate directly with transportation management system 1502 or through another provider computing device, such as provider computing device 1516. In some embodiments, a requestor computing device (e.g., device 1524) may communicate via a connection 1526 directly with transportation management vehicle device 1518 via a communication channel and/or connection, such as a peer-to-peer connection, Bluetooth connection, NFC connection, ad hoc wireless network, and/or any other communication channel or connection. Although FIG. 15 shows particular devices communicating with transportation management system 1502 over networks 1510 and 1512, in various embodiments, transportation management system 1502 may expose an interface, such as an application programming interface (API) or service provider interface (SPI) to enable various third parties which may serve as an intermediary between end users and transportation management system 1502.

In some embodiments, devices within a vehicle may be interconnected. For example, any combination of the following may be communicatively connected: vehicle 1514, provider computing device 1516, provider tablet 1520, transportation management vehicle device 1518, requestor computing device 1524, requestor tablet 1522, and any other device (e.g., smart watch, smart tags, etc.). For example, transportation management vehicle device 1518 may be communicatively connected to provider computing device 1516 and/or requestor computing device 1524. Transportation management vehicle device 1518 may establish communicative connections, such as connections 1526 and 1528, to those devices via any suitable communication technology, including, e.g., WLAN technologies implementing the IEEE 902.12 family of standards, Bluetooth, Bluetooth Low Energy, NFC, Z-Wave, ZigBee, and any other suitable short-range wireless communication technology.

In some embodiments, users may utilize and interface with one or more services provided by the transportation management system 1502 using applications executing on their respective computing devices (e.g., 1516, 1518, 1520, and/or a computing device integrated within vehicle 1514), which may include mobile devices (e.g., an iPhone®, an iPad®, mobile telephone, tablet computer, a personal digital assistant (PDA)), laptops, wearable devices (e.g., smart watch, smart glasses, head mounted displays, etc.), thin client devices, gaming consoles, and any other computing devices. In some embodiments, vehicle 1514 may include a vehicle-integrated computing device, such as a vehicle navigation system, or other computing device integrated with the vehicle itself, such as the management system of an autonomous vehicle. The computing device may run on any suitable operating systems, such as Android®, iOS®, macOS®, Windows®, Linux®, UNIX®, or UNIX®-based or Linux®-based operating systems, or other operating systems. The computing device may further be configured to send and receive data over the Internet, short message service (SMS), email, and various other messaging applications and/or communication protocols. In some embodiments, one or more software applications may be installed on the computing device of a provider or requestor, including an application associated with transportation management system 1502. The transportation application may, for example, be distributed by an entity associated with the transportation management system via any distribution channel, such as an online source from which applications may be downloaded. Additional third-party applications unassociated with the transportation management system may also be installed on the computing device. In some embodiments, the transportation application may communicate or share data and resources with one or more of the installed third-party applications.

FIG. 16 shows a data collection and application management environment 1600, in accordance with various embodiments. As shown in FIG. 16, management system 1602 may be configured to collect data from various data collection devices 1604 through a data collection interface 1606. As discussed above, management system 1602 may include one or more computers and/or servers or any combination thereof. Data collection devices 1604 may include, but are not limited to, user devices (including provider and requestor computing devices, such as those discussed above), provider communication devices, laptop or desktop computers, vehicle data (e.g., from sensors integrated into or otherwise connected to vehicles), ground-based or satellite-based sources (e.g., location data, traffic data, weather data, etc.), or other sensor data (e.g., roadway embedded sensors, traffic sensors, etc.). Data collection interface 1606 can include, e.g., an extensible device framework configured to support interfaces for each data collection device. In various embodiments, data collection interface 1606 may be extended to support new data collection devices as they are released and/or to update existing interfaces to support changes to existing data collection devices. In various embodiments, data collection devices may communicate with data collection interface 1606 over one or more networks. The networks may include any network or communication protocol as would be recognized by one of ordinary skill in the art, including those networks discussed above.

As shown in FIG. 16, data received from data collection devices 1604 can be stored in data store 1608. Data store 1608 may include one or more data stores, such as databases, object storage systems and services, cloud-based storage services, and other data stores. For example, various data stores may be implemented on a non-transitory storage medium accessible to management system 1602, such as historical data store 1610, ride data store 1612, and user data store 1614. Data stores 1608 can be local to management system 1602, or remote and accessible over a network, such as those networks discussed above or a storage-area network or other networked storage system. In various embodiments, historical data 1610 may include historical traffic data, weather data, request data, road condition data, or any other data for a given region or regions received from various data collection devices. Ride data 1612 may include route data, request data, timing data, and other ride related data, in aggregate and/or by requestor or provider. User data 1614 may include user account data, preferences, location history, and other user-specific data. Although certain data stores are shown by way of example, any data collected and/or stored according to the various embodiments described herein may be stored in data stores 1608.

As shown in FIG. 16, an application interface 1616 can be provided by management system 1602 to enable various apps 1618 to access data and/or services available through management system 1602. Apps 1618 may run on various user devices (including provider and requestor computing devices, such as those discussed above) and/or may include cloud-based or other distributed apps configured to run across various devices (e.g., computers, servers, or combinations thereof). Apps 1618 may include, e.g., aggregation and/or reporting apps which may utilize data 1608 to provide various services (e.g., third-party ride request and management apps). In various embodiments, application interface 1616 can include an API and/or SPI enabling third party development of apps 1618. In some embodiments, application interface 1616 may include a web interface, enabling web-based access to data 1608 and/or services provided by management system 1602. In various embodiments, apps 1618 may run on devices configured to communicate with application interface 1616 over one or more networks. The networks may include any network or communication protocol as would be recognized by one of ordinary skill in the art, including those networks discussed above, in accordance with an embodiment of the present disclosure.

While various embodiments of the present disclosure are described in terms of a networked transportation system in which the ride providers are human drivers operating their own vehicles, in other embodiments, the techniques described herein may also be used in environments in which ride requests are fulfilled using autonomous or semi-autonomous vehicles. For example, a transportation management system of a networked transportation service may facilitate the fulfillment of ride requests using both human drivers and autonomous vehicles. Additionally or alternatively, without limitation to transportation services, a matching system for any service may facilitate the fulfillment of requests using both human drivers and autonomous vehicles.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a non-transitory memory; and
one or more hardware processors configured to execute instructions from the non-transitory memory to perform operations comprising:
receiving a transportation request from a requestor device;
identifying a set of transportation provider devices;
determining an acceptance probability, for the transportation request, for each provider device in the identified set of transportation provider devices;
matching a provider device from the set of transportation provider devices to the transportation request based on the acceptance probability of the provider device; and
sending the transportation request to the provider device.

2. The system of claim 1, wherein the one or more hardware processors are configured to execute instructions from the non-transitory memory to determine the acceptance probability of the provider device by determining a likelihood of the provider device accepting a match to the transportation request by comparing the transportation request with a historical record of transportation requests sent to the provider device.

3. The system of claim 2, wherein the historical record of transportation requests sent to the provider device comprises data associated with at least one of:
an estimated time of arrival from a provider device's location to a starting location of a previous transportation request;
an actual time of arrival from the provider device's location to the starting location of the previous transportation request;
a route of the previous transportation request;
a mode of transportation used by the requestor;
an idle time of the provider device prior to receiving the previous transportation request;
a number of other active provider devices within a range of the provider device; or
a number of other active requestor devices within the range of the provider device.

4. The system of claim 2, wherein the historical record of transportation requests sent to the provider device comprises:
a status indicating at least one of:
the provider device accepting a previous transportation request;
the provider device declining the previous transportation request;
the provider device fulfilling the previous transportation request; or
a lapse of the provider device for the previous transportation request; and
an updated historical record of transportation requests sent to the provider device based on tracking a status of the transportation request.

5. The system of claim 2, wherein the one or more hardware processors are configured to execute instructions from the non-transitory memory to determine the acceptance probability of the provider device by adjusting the likelihood of the provider device accepting the match based on a recent historical record of the provider device, wherein the recent historical record comprises a portion of the historical record within a time frame.

6. The system of claim 1, wherein the one or more hardware processors are configured to execute instructions from the non-transitory memory to match the provider device to the transportation request by further:
calculating a conversion score for each provider device based on:
the acceptance probability;
a probability of an acceptance of the transportation request converting to a physical transport; and
a probability of the requestor device canceling the transportation request; and
matching the provider device to the transportation request based on the conversion score of the provider device.

7. The system of claim 6, wherein the one or more hardware processors are configured to execute instructions from the non-transitory memory to perform further operations comprising:
receiving at least one additional transportation request from at least one additional requestor device;
adjusting the acceptance probability of the provider device for the transportation request based on the at least one additional transportation request;
determining, based on the adjustment, that the at least one additional transportation request has a higher conversion score than the transportation request for the provider device; and
matching the provider device to an alternate transportation request based on the higher conversion score.

8. A computer-implemented method comprising:
receiving, at a dynamic transportation matching system, a transportation request from a requestor device;
identifying a set of transportation provider devices;
determining an acceptance probability, for the transportation request, for each provider device in the identified set of transportation provider devices;
matching a provider device from the set of transportation provider devices to the transportation request based on the acceptance probability of the provider device; and
sending, from the dynamic transportation matching system, the transportation request to the provider device.

9. The computer-implemented method of claim 8, wherein determining the acceptance probability of the provider device comprises determining a likelihood of the provider device accepting a match to the transportation request by comparing the transportation request with a historical record of transportation requests sent to the provider device.

10. The computer-implemented method of claim 9, wherein the historical record of transportation requests sent to the provider device comprises data associated with at least one of:
an estimated time of arrival from a provider device's location to a starting location of a previous transportation request;
an actual time of arrival from the provider device's location to the starting location of the previous transportation request;
a route of the previous transportation request;
a mode of transportation used by the requestor;
an idle time of the provider device prior to receiving the previous transportation request;
a number of other active provider devices within a range of the provider device; or
a number of other active requestor devices within the range of the provider device.

11. The computer-implemented method of claim 9, wherein the historical record of transportation requests sent to the provider device comprises:
a status indicating at least one of:
the provider device accepting a previous transportation request;
the provider device declining the previous transportation request;
the provider device fulfilling the previous transportation request; or
a lapse of the provider device for the previous transportation request; and
an updated historical record of transportation requests sent to the provider device based on tracking a status of the transportation request.

12. The computer-implemented method of claim 9, wherein determining the acceptance probability of the provider device comprises adjusting the likelihood of the provider device accepting the match based on a recent historical record of the provider device, wherein the recent historical record comprises a portion of the historical record within a time frame.

13. The computer-implemented method of claim 8, wherein matching the provider device to the transportation request further comprises:
calculating a conversion score for each provider device based on:
the acceptance probability;
a probability of an acceptance of the transportation request converting to a physical transport; and
a probability of the requestor device canceling the transportation request; and
matching the provider device to the transportation request based on the conversion score of the provider device.

14. The computer-implemented method of claim 13, further comprising:
receiving at least one additional transportation request from at least one additional requestor device;
adjusting the acceptance probability of the provider device for the transportation request based on the at least one additional transportation request;
determining, based on the adjustment, that the at least one additional transportation request has a higher conversion score than the transportation request for the provider device; and
matching the provider device to an alternate transportation request based on the higher conversion score.

15. A computer-readable medium comprising:
computer-readable instructions that, when executed by at least one processor of a computing device, cause the computing device to:
receive a transportation request from a requestor device;
identify a set of transportation provider devices;
determine an acceptance probability, for the transportation request, for each provider device in the identified set of transportation provider devices;
match a provider device from the set of transportation provider devices to the transportation request based on the acceptance probability of the provider device; and
send the transportation request to the provider device.

16. The computer-readable medium of claim 15, wherein the computer-readable instructions cause the computing device to determine the acceptance probability of the provider device by determining a likelihood of the provider device accepting a match to the transportation request by comparing the transportation request with a historical record of transportation requests sent to the provider device.

17. The computer-readable medium of claim 16, wherein the historical record of transportation requests sent to the provider device comprises data associated with at least one of:
an estimated time of arrival from a provider device's location to a starting location of a previous transportation request;
an actual time of arrival from the provider device's location to the starting location of the previous transportation request;
a route of the previous transportation request;
a mode of transportation used by the requestor;
an idle time of the provider device prior to receiving the previous transportation request;
a number of other active provider devices within a range of the provider device; or
a number of other active requestor devices within the range of the provider device.

18. The computer-readable medium of claim 16, wherein the historical record of transportation requests sent to the provider device comprises:
a status indicating at least one of:
the provider device accepting a previous transportation request;
the provider device declining the previous transportation request;
the provider device fulfilling the previous transportation request; or
a lapse of the provider device for the previous transportation request; and
an updated historical record of transportation requests sent to the provider device based on tracking a status of the transportation request.

19. The computer-readable medium of claim 16, wherein the computer-readable instructions cause the computing device to determine the acceptance probability of the provider device by adjusting the likelihood of the provider device accepting the match based on a recent historical record of the provider device, wherein the recent historical record comprises a portion of the historical record within a time frame.

20. The computer-readable medium of claim 15, wherein the computer-readable instructions cause the computing device to match the provider device to the transportation request by further:
calculating a conversion score for each provider device based on:
the acceptance probability;
a probability of an acceptance of the transportation request converting to a physical transport; and
a probability of the requestor device canceling the transportation request; and
matching the provider device to the transportation request based on the conversion score of the provider device.
